(19) United States
(12) Patent Application Publication
(10) Pub. No.: US 2026/0002272 A1
(43) Pub. Date: Jan. 1, 2026

(54) METHOD OF ASSEMBLY OF A WATER ELECTROLYSIS STACK, BIPOLAR PLATES CONFIGURED FOR USE IN AN ELECTROLYSER STACK AND USE OF BIPOLAR PLATES

(71) Applicant: GREEN HYDROGEN SYSTEMS A/S, Kolding (DK)

(72) Inventors: Morten Tvedskov NIELSEN, Kolding (DK); Anders Rønne RASMUSSEN, Kolding (DK); Christian Buhl SØRENSEN, Kolding (DK)

(21) Appl. No.: 18/880,552

(22) PCT Filed: Jun. 30, 2023
(86) PCT No.: PCT/EP2023/068041

§ 371 Date: Jan. 1, 2025

(30) Foreign Application Priority Data
Jul. 1, 2022 (DK) PA202200635

(51) Int. Cl. C25B 11/036; C25B 9/75; C25B 9/77; C25B 13/02

(52) U.S. Cl. CPC C25B 11/036; C25B 9/75; C25B 9/77; C25B 13/02

(57) ABSTRACT

Bipolar plates (1) adapted for use in an electrolyser cell stack (4) and wherein each plate comprises a plate midplane (2) whereby the plate (1) comprises spaced apart uniform spacers (7) extending in opposed directions from the midplane (2). All spacers (7) are arranged along concentric circles (8) in the midplane (2) with spacers (7) alternatingly protruding in opposite directions relative to the midplane (2) along each concentric circle (8) and an even number of spacers (7) are provided in each circumferential circle (8), apart from an innermost circle (9) which comprises a single spacer (7).

The present invention relates to a method of assembling a water electrolysis stack. Further, the present invention relates to bipolar plates configured for use in an electrolyser stack. Yet further, the present invention relates to a use of bipolar plates.

### BACKGROUND OF THE INVENTION

The bipolar plates used in electrolysers for water electrolysis, such as in pressurised water electrolysers, have the electrodes (cathode and anode) arranged at opposite sides of the plates, and usually welded to bumps, which could also be called protrusions, which protrusions extend orthogonally to a midplane of the bipolar plate and in opposite directions away from the plates. The protrusions ensure that a distance between the bipolar plate and the electrode is provided, wherein the electrolyte may flow and be continually exchanged during use of the electrolyser. Between any two consecutive bipolar plates of an electrolyser of the above kind, a sandwich comprising electrode-diaphragm-electrode (also named EDE sandwich) shall reside, the two electrodes being always a cathode and an anode. It is important, that there is no gap between the electrodes and the diaphragm. It has surprisingly been learned that protrusions, which are aligned opposite each other on each side of the EDE sandwich may result in a less than desirable zero gap relationship between diaphragm and electrodes. Especially in the regions near the outer perimeter of the bipolar plates, this may be a pronounced problem, especially when protrusions are not evenly distributed along the outer perimeter of the bipolar plates. If small pressure differences between the two sides of a diaphragm arises, the electrode material, if it is compliant in some measure, may be deformed permanently, and thus allow a permanent space between electrode material and diaphragm, which is highly undesirable. It is also important in some types of electrodes, that they be oriented correctly according to a dominating flow direction within the electrolyser chambers bordering the two sides of each bipolar plate in an electrolyser. Thus, bipolar plates are desired, which differs from prior art plates, and which will allow an improved assembly method to be used, and furthermore allow an improved stack to be assembled.

### SUMMARY OF THE INVENTION

In a first aspect of the invention, the objects may be achieved by bipolar plates configured for use in an electrolyser cell stack, wherein each bipolar plate comprises two opposed surfaces and spaced apart spacers extending outwards from a surface of the bipolar plate, wherein the spacers are arranged along concentric circles with spacers alternatingly protruding in opposite directions from the opposed surfaces and relative to a midplane (2) of the bipolar plate (1) along each concentric circle (8), and wherein an even number of spacers (7) are provided in each circumferential circle (8).

The invention also concerns bipolar plates configured for use in an electrolyser cell stack, wherein each polar plate comprises a plate midplane, and whereby the plate comprises spaced apart uniform spacers extending in opposed directions from the midplane. Further, according to the invention, all spacers are arranged along concentric circles with spacers alternatingly protruding in opposite directions relative to the midplane along each concentric circle, and whereby an even number of spacers are provided in each circumferential circle

When spacers are aligned along concentric circles which are arranged concentrically with the centre of the round bipolar plate, there will be an outermost of the concentric circles with spacers, and as they also intermittently protrude, in each of the two directions, away from the plate, an even distribution of spacers will be achieved along the periphery of the bipolar plate. When all spacers, irrespective of whichever way they protrude, are mapped out identically in all plates, it further becomes easy to rotate any bipolar plate around a center axis of a plate during assembly and place it in a predefined angular position and especially, to rotate it into an angular position identical to the angular position of a below plate. If this is done throughout the stack, all spacers shall inevitably be aligned along axes parallel to the length axis of the stack, and if the plates are also not overturned with respect to each other, all spacers shall be aligned along axes parallel to the centre axis of the stack and all spacers aligned in any such axis shall protrude in the same direction.

The manufacturing of the plate to comprise spacers will usually comprise a deep drawing operation in one or more steps. The spacers may be produced one by one in a numerically controlled deep drawer, or possibly all spacers protruding in one direction or all spacers protruding in both directions are produced in operations, such as deep draw operations, by rolling or any other known manner.

In some embodiments, the spacers are formed as protrusions (or bumps) from the plate.

In a further embodiment, the spacers are formed as essentially semi-spherical protrusions, protruding from the plate.

In a further embodiments, the protrusions forming the spacers each comprises a flat top part.

In a further embodiment of the invention, the bipolar plates are made such that the nominal thickness of an EDE comprising an electrode, a diaphragm and yet an electrode exceeds the distance between two adjacent virtual planes with a predetermined measure, where the virtual planes inscribe the flat tops of the spacers.

The cell is here defined as consisting of the following
a bipolar plate,
the spacers therein extending into the first half cell (anode containing or cathode containing) and contacting the first electrode,
the first electrode,
a diaphragm,
the next electrode,
the next half cell (anode containing or cathode containing) and
the spacers extending into this half-cell from the next bipolar plate.

The next bipolar plate itself is counted as part of the next entire cell. To each such cell, a cell frame for the bipolar plate and a cell frame for the diaphragm is provided. When the cell stack is assembled, the entire stack of cell frames shall be pressured towards each other between the endplates by means of the pull rods, and any soft parts (such as diaphragms and/or electrodes) must give way and assume the combined thickness of the two cell frames, at least while the cell frames are urged against each other. If the diaphragm is a rather soft and flexible, sheet-formed and somewhat spungy and elastically stretchable element and the electrodes on each side, are also made from a flexible material as is the case with the presented EDE sandwich, and if further the spacers have little flexibility in the direction normal to the bipolar plates, then the EDE sandwich shall flex and assume an undulated shape when subject to the pressure from two sides from the mis-aligned spacers. This means, that seen from a first side, there will be shallow valleys around spacers pressuring down on the first side, and flat “hills” around areas where spacers are pressuring the sandwich from an opposed side. In this slightly undulated state, the diaphragm shall be stretched slightly, and the combined effect of the stretch and undulation shall ensure, that a zero-gap relation between the diaphragm and the electrode on each side thereof remains.

The undulation is defined as the measure between hill tops and valleys in the direction normal to the bipolar plate.

The combined nominal thickness of the EDE element shall preferably exceed the distance between adjacent virtual planes by a predetermined measure.

If the spacers from opposing bipolar plates in a half cell which protrude towards the half-cell are aligned, the undulation is not possible, as the EDE in this case will be pressured from opposed sides by spacers which sits opposite each other, and an EDE sandwich which is thicker than the distance between opposed virtual planes is not possible without causing damage to the diaphragms and/or the electrodes.

The distance, v, between virtual planes may be zero, and in this case, any EDE sandwich shall give rise to an undulation which corresponds to the thickness of the EDE sandwich. v may well be negative; in which case the undulation shall comprise the sum of the EDE thickness and the distance v (with positive indicator sign).

In an embodiment, it is preferred for the distance v to be negative. The distance v is preferably from −0.1 mm to −1.0 mm.

In an embodiment, the EDE sandwich comprises a diaphragm, which is between 0.1 mm and 0.5 mm thick, and comprise electrodes that are between 0.1 mm and 0.3 mm thick each. The thinnest possible EDE sandwich under these constraints is thus 0.3 mm and the thickest is 1.1 mm.

The upper limit to undulation is defined by spacer height, h, as the thickness of the EDE sandwich minus v which also corresponds to the undulation shall not exceed the height h. In a preferred embodiment v is −0.3 mm and the EDE sandwich is 1.1 mm, while h is 4.90 mm. This leaves a head space above the hills of:

$$4.9 mm - ( 1.1 mm - ( - 0.3 mm ) ) = 4.9 mm - 1.4 mm = 3.5 mm .$$

In an embodiment, the bipolar plates each have at least one orientation tab and/or indent which is provided in each bipolar plate radially external to the outermost circle of spacers whereby the orientation tab and/or indent is located at the same location with respect to the spacers in all plates, such that any spacer is mapped out with respect to at least one tab and/or indent in the same way in all plates.

The orientation tabs and/or indents provided at the rim of each bipolar plate aids in aligning the plates with respect to each other. Especially if a corresponding tab/indent is provided in each cell frame, as in this case, the bipolar plate may be arranged in the cell according to the orientation feature of the cell frame and bipolar plate. This is doable, as cell frames used for the bipolar plates are stacked with respect to each other in the same way throughout one cell stack.

In an embodiment, in the bipolar plates, each spacer comprises a circular conical shoulder part rising from the midplane and a flat circular top and rounded interface between the midplane and shoulder parts and similarly rounded interface between the shoulder part and the flat top.

The flat top may serve as a welding surface whereto the electrode is fastened, and the shoulder parts, with rounded interfaces are instrumental in both ensuring a smooth flow around any spacer and ensuring that the spacers may be pressed or drawn out from the plate material of the bipolar plate in a well-known process of manufacturing. The electrode is made from a stretchable material such as stretch metal or the like, so that between spacers the electrode may deviate from a plane shape as will be necessary when the stack is assembled.

In an embodiment, the flat tops of spacers protruding from the bipolar plates are inscribed in a virtual plane, and this virtual plane is parallel to the midplane of the plate from which the spacers protrude, and further, if the distance between the virtual plane and the midplane is h and the diameter of the outermost of the concentric circles is D, then the D/h size relation is no smaller than 100 and no bigger than 135 and preferably is between 115 and 125.

The flat tops of the spacers being inscribed in the virtual plane is to be construed mathematically such that the sum of distances between the flat tops and the virtual plane is minimized under the condition that the virtual plane extends in parallel to the midplane of the bipolar plate. The D/h size relation is chosen to ensure, that a reasonable flow in the cell may be accomplished without overly large pump capacity. Also, this relation is instrumental in securing an undulation, which is aggregable given the materials used for the EDE, also if a larger or somewhat smaller plate should be desired. In an embodiment the D/h measure equals 122.

In an embodiment, in the bipolar plates, the number of concentric circles is no less than 7.

Further, the concentric circles may be arranged with equal distances between them, such that in a section through the centre of the concentric circles of spacers, the radial distance from one concentric circle to the next is the same throughout the bipolar plate.

Having the concentric circles arranged with same distances helps in ensuring that spacers are evenly distributed on the plate. Arranging spacers exactly evenly distributed along each concentric circle is possible, but small variations are bound to exist between individual circles in terms of distances between spacers due to geometric and numeric constraints. This is of little or no consequence as an overall even distribution of spacers will be possible, so that no larger areas of the bipolar plate is left without spacers.

In a further embodiment, a single spacer may further be provided in the centre of the concentric circles.

In another aspect, the objects of the invention are achieved by the use of bipolar plates as defined in in any one of the embodiments of the first aspect of the invention, and wherein during use, the plates are arranged in a stack with the EDE sandwich pressurized between spacers of individual plates, and further, all bipolar plates have at least one orientation tab/indent aligned rotationally with respect to each other in the stack and are further flipped such that all spacers in the plates in a cell stack which are aligned along one length axis direction of the stack shall protrude in one predetermined direction only. When the bipolar plates are used in this fashion, they can ensure that the EDE sandwich is pressurized from two opposed sides without points of concentrated stresses. The stress shall be more evenly distributed such that a construction having a nominal thickness of the EDE sandwich which exceeds the distance between spacer surface virtual planes in two assembled adjacent half-cells shall be workable or even advantageous. In such an assembly, the zero-gap desired between diaphragms and their adjacent electrodes is improved. As stresses are distributed over the diaphragm and the adjacent electrodes, electrodes overall may accept higher pressure differences between the two sides of a membrane before they are permanently damaged.

In a third aspect, the invention concerns a method of assembly of a water electrolysis stack holding, among others, a range of identical bipolar plates which have arrays of spacers extending away from a midplane in two opposed directions. According to this aspect, the bipolar plates throughout the stack are arranged during assembly, such that all spacers in the range of plates are aligned along axes, which are parallel to the length axis of the stack, and further, all spacers along any one alignment axis protrude in one and the same direction.

As long as the spacers in question are aligned along one and the same alignment axis, which is parallel to a stack centre axis, they shall protrude in one direction only. Preferably the arrays of spacers comprise spacers arranged in concentric circles and in such a manner, that spacers alternatingly protrude in each their direction along each circle. This arrangement of spacers ensures that spacers protruding towards the same EDE sandwich from each their side thereof are never in alignment, and a more even distribution of stresses in the EDE shall be obtained.

In an embodiment of the method of assembly, during assembly, a nominal height measure of the EDE elements of a cell exceed the distance between the virtual planes comprising the flat tops of spacers in opposed bipolar plates, such that the EDE elements between the spacers are caused to undulate between the two arrays of spacers in the opposed bipolar plates as the stack elements are pressed against each other.

This method of assembly ensures a very stable zero gap distance between the diaphragm and the electrode on each side thereof, also when the pressure differences between the two sides of the EDE are not always within the prescribed limits.

According to an embodiment of the assembly method, at least one orientation tab and/or indent provided along an edge part of the otherwise circular bipolar plate is co-aligned with respect to a corresponding tab and/or indent at a cell frame onto which the bipolar plate is mounted during assembly.

In this way, all plates shall be aligned in the same manner in a stack, as every other cell frame shall be stacked in the exact same rotational position, and thus receive the bipolar plate oriented according to a below or above arranged bipolar plate in the stack. Every cell frame arranged between two cell frames carrying a bipolar plate shall be charged with a diaphragm to form the EDE sandwich.

In yet another embodiment of the method of assembly, it is ensured that prior to adding a bipolar plate to a cell frame, each spacer protruding from a first side of the bipolar plate is welded to an electrode and that each spacer protruding from a second side of the bipolar plate is welded to a further electrode, whereby the electrodes prior to the welding operation are rotated such that an orientation marker on the electrode is orientated in a predefined manner with respect to an orientation feature in the corresponding bipolar plate.

This predefined orientation of the electrode with respect to the bipolar plate will allow a uniform orientation of all electrodes in a stack. Such an orientation may be important to certain types of electrodes which are sensitive to the flow direction in the cell. These electrodes need to always have the electrolyte flow in a predefined principal flow direction with respect to their mechanical build. And thus, they need to be oriented according to inlet and outlet in each individual half-cell. Inlets and outlets as such are not marked on the bipolar plate, however, when the bipolar plates are arranged in the cell frame as described, the inlet and outlet will be defined, and the electrodes thus need only to be oriented correctly with respect to the bipolar plate in order to receive the flow of electrolyte from the preferred direction when mounted in the cell frame which defines the inlet and outlet.

In a further embodiment of the assembly method, during assembly, the bipolar plates are either all rotated and/or flipped to have the cathode electrode face an endplate with inlets and outlets for the electrolysis processes in the assembled stack, or the bipolar plates are all rotated and/or overturned to have the cathode electrode face away from the endplate with the inlets.

In a well-known electrolyser configuration, two stacks are electrically interconnected, such that an electrical high potential (such as electrical positive potential) is supplied to the far end of one of the stacks, and at an opposed near end or proximal end of the stack, an electrical connection to the proximal end of the next stack is established. Further, this next stack is supplied with a high potential at its far or distal end, however, with the opposite sign from the potential supplied at the far end of the first stack and in this case that would be an electrical negative potential. At the proximal ends of the two stacks, a near zero potential shall reside, under the condition that the two stack realises equal electrical potential loss, which is the usual case. At these zero potential ends of the stacks, connections for the supply and extraction of the electrolytic fluids are customarily arranged. In such an arrangement, the bipolar plates with electrodes are to face in opposite directions with respect to the zero potential or proximal end of the stack to face the correct electrical potential in both stacks. To this end, it is advantageous that the bipolar plates are rotated about a diameter axis (flipped) such that the cathode or anode part of the electrodes adhering to the bipolar plates may be arranged to face either the proximal or the distal end of the stack.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of uncited features. The features recited in dependent claims are mutually freely combinable unless otherwise explicitly states. Furthermore, it is to be understood that the use of “a” or “an”, i.e. a singular form, throughout this document does not exclude a plurality.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1A is a schematic representation of a sliced section through two bipolar plates according to the invention,

FIG. 1B is a schematic representation of a sliced section through two bipolar plates according to a prior art configuration,

FIG. 2 is a drawing of a plane view of the spacer pattern on one side of a prior art bipolar plate,

FIG. 3 is a plane view of a spacer pattern for the two sides of a bipolar plate with orientation features shown in enlarged view,

FIG. 4 shows an enlarged view of a possible orientation tab,

FIG. 5 shows a plane view of the spacers on one side only,

FIG. 6A shows a view (photo) of an electrode with orientation feature shown in an enlarged view,

FIG. 6B is a rough sketch of the electrode photo of FIG. 6A,

FIG. 6C is a representation of a brilliant (diamond cut) shape for reference,

FIG. 7 is a schematic representation of an electrode and a bipolar plate, both with orientation indent,

FIG. 8 shows a sectional view of bipolar plate with its two electrodes and an enlarged view of a part,

FIG. 9 is an enlarged sectional view through one spacer,

FIG. 10 shows 2 cell stacks in a 3D sectional view,

FIG. 11 two cell frame details are disclosed in each their plane view is shown,

FIG. 12 displays the details seen in FIG. 11 as they appear on a cell frame,

FIG. 13 shows a sliced sectional view of an undulating EDE between two arrays of spacers protruding towards the EDE from opposed directions and

FIG. 14 shows the distance v in an instance where the distance is negative.

### DETAILED DESCRIPTION OF THE EMBODIMENTS

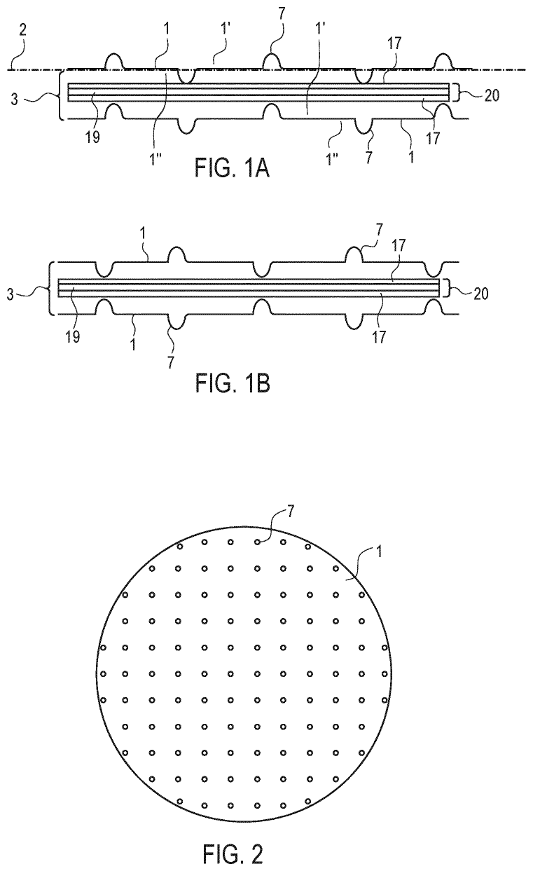

FIG. 1A and FIG. 1B show two embodiments of a set comprising two bipolar plates 1. In each embodiment, each bipolar plate 1 comprises two opposed surfaces 1′, 1″, a first or upwardly facing surface 1′ and a second, or downwardly facing surface 1″, as well as a plurality of spaced apart spacers 7, each of which spacers 7 extend outwards from either the first surface 1′ of the bipolar plate 1 or the second surface 1″ of the bipolar plate 1. In each embodiment, both the bipolar plates 1 (or simply plates 1) have an electrode 17 welded to spacers 7 formed on, and extending outward from, the plates 1. In the embodiments shown, the spacers 7 are provided as protrusions formed as e.g. deep drawn indentations in the plate 1. Each protruding spacer 7 has a flat top 13. In the embodiments shown in FIGS. 1A and 1B, the flat top 13 of the spacer 7 is a circular flat top 13. The electrode 17 is welded to the flat circular tops 13 of a spacers 7 or protrusions. In each of the embodiments, shown in FIG. 1A and 1 B, respectively, the uppermost bipolar plate 1 displays an electrode 17 at its lower side, and the lowermost plate 1 shows the electrode 17 at its upper side. Between the electrodes 17, a diaphragm 19 is provided, and it is desired, that the electrodes 17 in both sides thereof always remain in a zero-gap configuration with the diaphragm 19 at any point of the diaphragm. In a cell stack configuration, electrodes 17 shall be welded to both sides of all bipolar plates 1.

In FIG. 1A it is shown, that spacers 7 of the upper and the lower plates are aligned and have the same orientation. Thus, any upwards directed spacer in the lower plate sits right below a similarly upwards directed spacer in the upper plate in the figure. This ensures that at no point, will a set of spacers which both protrude towards the EDE on the two sides thereof be aligned.

FIG. 1A further shows a midplane 2 of the uppermost bipolar plate 1. The spacers 7 can also be considered as extending in opposite directions from the midplane 2. It will be appreciated that each bipolar plate 1 has a midplane 2.

In some embodiments, and as shown in e.g. FIG. 1A, the spacers 7 are formed as protrusions (or bumps), extending from the bipolar plate 1 (plate 1).

In some embodiments, and as shown in e.g. FIG. 1A, the spacers 7 are formed as essentially semi-spherical protrusions, protruding from the bipolar plate 1.

In a further embodiments, the protrusions forming the spacers 7 each comprises a flat top part 13.

FIG. 1B is a possible prior art configuration of the elements shown in FIG. 1A. Here the downward directed spacers 7 in the upper bipolar plate 1 are aligned with the upward directed spacers 7 in the lower of the two shown bipolar plates 1. Thus, the EDE sandwich 20 appears to be pinched between the aligned spacers. Especially at elevated pressure differences between the pressure on a cathode side and an anode side of the diaphragm in a stack, the EDE sandwich 20 may suffer, and electrodes can become permanently deformed, which will lead to a gap between diaphragm and electrode, which is undesirable. Further, in this prior art construction, it is not easy to accommodate manufacturing tolerances as any oversizing of the EDE will inevitably lead to either the diaphragm, the electrodes, or both being overly pinched between spacers, or if the EDE is undersized, a gap between the diaphragm and the electrode is most likely to materialize to the detriment of the efficiency of the electrolyser stack.

A cell stack 4 comprises a number of electrolyser cells 3 provided in a row next to each other. The cell frames 5 are pressured against each other between two opposed endplates 6, 23 to form alternating catalytic and analytic process chambers separated from each other by diaphragms 19. An electrolytic cell 3 may then comprise the following stack members in the mentioned order: bipolar plate, electrode (cathode or anode), diaphragm, electrode (cathode or anode). Thus, every other cell frame is charged with a bipolar plate and the electrodes in either side thereof, and every other cell frame is charged with a diaphragm. If the first electrode is an anode, the electrode following the diaphragm is a cathode and vice versa.

In FIG. 2, the spacers 7 in a prior art plate protruding the one way away from the plate plane are shown, and it is visualised how they are aligned along straight vertical and horizontal lines in a 2D array. Any four such neighbouring spacers will form the corners of a rectangle. It is also shown, that near the edges of the plate, some rather large patches are without spacers. This increases the risk of parts of the rim areas of the diaphragm remaining un-supported. Extra spacers could be added; however, they would inevitably result in spacers being closer together on the plate than average, and this would lead to spacers providing un-desired obstacles for the uniform flow of electrolyte in the space between the spacer and the diaphragm along the plane of the plate, and also even if spacers were added to a prior art plate, these could not in any reasonable way be made to protrude in the same direction on adjacent plates while adding to the support of the EDE.

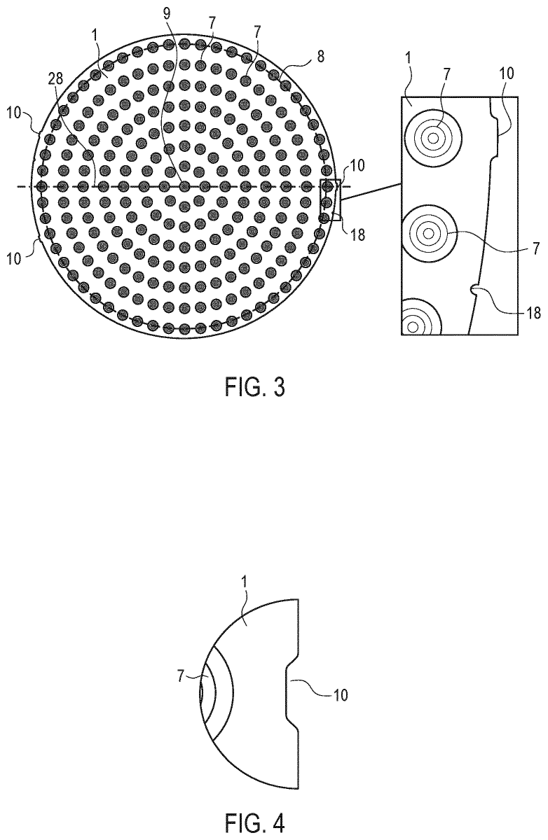

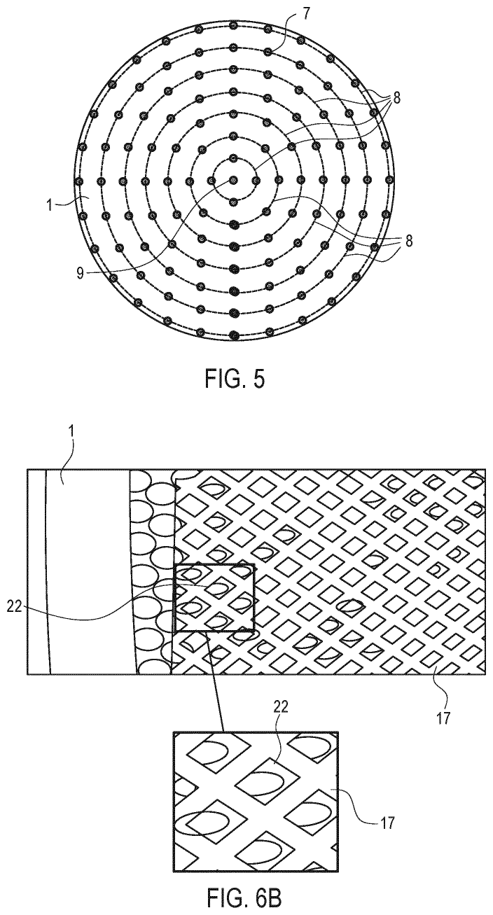

In FIG. 3, a plane view of a plate 1 according to the invention is disclosed, whereby both spacers pointing towards and away from the viewer are shown. All spacers 7 are arranged along concentric circles 8 and along each circle, spacers 7 alternatingly protrude in each their direction with respect to a midplane 2 of the plate 1. In FIG. 5, only spacers 7 protruding in one direction are disclosed, and here it is clear, that along the periphery of the circular plate, the spacers are evenly distributed. As also seen in FIGS. 3 and 5, there are seven concentric circles 8 plus the innermost circle 9, which comprise only one spacer. The single spacer 7 provided in the innermost circle 9 can also be considered to be formed at the centre of the concentric circles. All radial distances from one circle to the next are alike. Mathematically speaking, the plate comprises a midplane 2 defined by a normal vector (not shown), and the spacers protrude along this normal and its opposite. However, the plate shall be manufactured with the spacers with usual tolerances for metal plates having a thickness of around 0.5 mm.

A cell height, as indicated at reference number 3 in FIG. 1A shall in the stack direction correspond to the combined height of two cell frames: one frame 5 for a bipolar plate 1 and one frame 5 for the mounting of a diaphragm 19. The two frames are identical and their combined height shall correspond to the combined height of the EDE sandwich 20 and a bipolar plate 1 including the spacers on each side thereof. When this is ensured, ideally the diaphragms shall be in contact with the electrodes on each side thereof when the stack is assembled. However, manufacturing tolerances may at times lead to small gaps between diaphragm and electrodes, and events of unwanted pressure differences between the cathode and anode side of the diaphragm may lead to electrode injury, and as mentioned this may especially be a problem in prior art stack assemblies, where the spacers may be aligned on each side of a diaphragm. The misalignment of the spacers 7 directed towards the EDE sandwich according to the invention, as shown in FIG. 1A, allows for the combined height of the EDE sandwich 20 and bipolar plate to exceed the actual or nominal height of the parts. Thus, the inside of a cell shall have a combined height, which nominally exceeds the height of the two cell frames constituting the height of the cell when assembled. This is only possible as the misaligned spacers supporting the EDE sandwich 20, allows this sandwich to slightly undulate, and give way to the spacers, as the spacers 7 will be experienced as too high in each half-cell. It should be mentioned that the diaphragm at the cell inner rim, is maintained and fastened to the cell frame all around the inner perimeter of the cell frame. However, the diaphragm is usually an element with some elasticity and thus a small stretch of the material is acceptable, and this stretch will also contribute to ensure, that a zero-gap relationship between the diaphragm and the electrodes is maintained.

A plane inscribing the flat tops 13 of the spacers 7 is termed a virtual plane 16, and the distance between two such neighbouring planes 16 is to accommodate the EDE sandwich. The distance is termed v. If the distance v between the virtual planes 16 is zero, the flat tops of the spacers from the one plate will be aligned with the flat tops of the spacers on the next plate in a half cell. If the distance between the virtual planes is negative as shown in both FIG. 13 and FIG. 14, the flat tops of the downwardly directed spacers of a top plate, are lower down than the tops of the upwardly directed spacers of a below plate. In this case even an infinitely thin EDE sandwich shall undulate to reside between the upwards and downwards directed spacers such as shown in FIG. 13.

In an embodiment as shown in FIG. 13, the distance between the virtual planes v is −0.3 mm and the EDE has a combined thickness t of 1.1 mm. The diaphragm is 0.5 mm, and the two electrodes are each 0.3 mm in nominal thickness. This gives an undulation height of

$$t - v = 1.1 mm - ( - 0.3 mm ) = 1.4 mm ,$$

such that the nominal difference between the top of hills and the depths of valleys will be 1.4 mm.

If the distance from the top of a so named hill and to the midplane 2 of an oppositely arranged bipolar plate is termed headspace, it will be clear from FIG. 13, that the headspace is calculated as the height h of spacers minus the EDE thickness t plus the distance v (with indicator sign). In the example above the height the spacers h is 4.90 mm, the EDE thickness t is 1.10 mm and v is −0.30 mm thus providing a headspace of 4.90−1.1−0.3 mm=3.50 mm. The headspace should preferably not be zero or less. If the headspace exceeds the spacer hight h, the EDE sandwich is not in touch with the spacers, and zero gap cannot be maintained. The thickness of the bipolar plate has been ignored in this calculation but is easy to include but would not alter the results significantly.

In FIG. 3, three orientation tabs 10 are seen along the perimeter or rim 32 of the bipolar plate 1. The spacers 7 on all produced plates shall be mapped out with respect to the tabs 10. In the cell frames 5, which are usually injection moulded annular, flat, polymer elements, similarly arranged recesses 11 shall be provided, such that the plate shall fit into the cell frame 5 in only one rotational position with respect to the cell frame. As shown in FIG. 3, there are three such tabs 10, and they are arranged symmetrically with respect to a diameter line 20, and this allows for the plate 1 to be overturned or flipped (rotated about an axis running in the midplane 2) and still fit within the cell frame. This is required to ensure that all plates 1 have their spacers aligned as disclosed in FIG. 1A.

FIG. 4, in a top view, shows a detail of a bipolar plate 1, similar to the bipolar plate 1 shown in FIG. 3. In FIG. 4, an indent 10 is disclosed, which when added to the outer rim 32 of the bipolar plate 1, may work in the same fashion as the tab 10 in FIG. 3, with corresponding changes made to the cell frame 5.

FIG. 5 shows all the spacers 7 extending in one direction from a bipolar plate 1 according to the invention. As seen, along the periphery, the spacers 7 are evenly spaced apart from each other and follow the trace of a circle 8. As is clear from FIG. 3, the outermost circle of spacers on the plate 1 is concentrically arranged with respect to the circular outline of the plate 1. In FIG. 3 it is seen, that along each circle, the spacers protrude alternatingly each their way with respect to the plate midplane, and in order to accomplish this, an even number of spacers must be provided in each circle. Also, with this constraint, exactly the same distance between spacers along each circle will not be possible, however minor differences in distances between spacers from one circle to the other circles will not disturb the achieved effect of evenly distributed stresses in the EDE.

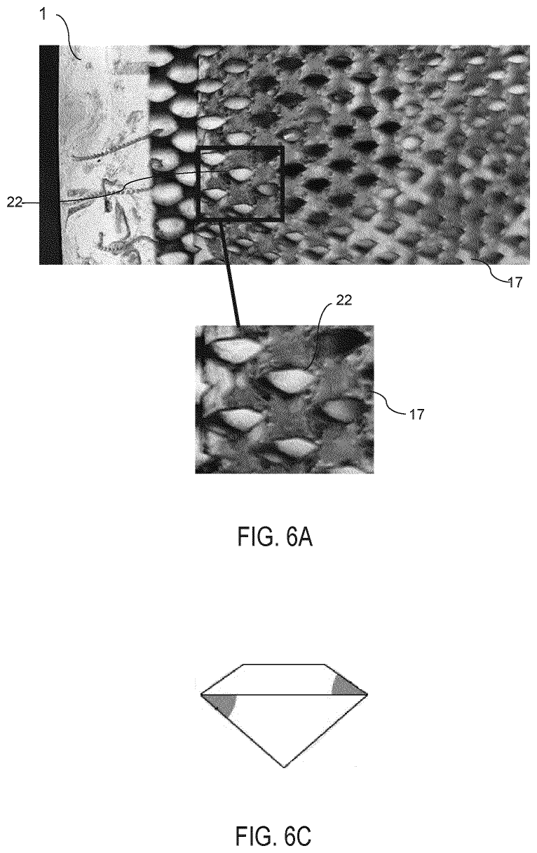

In FIG. 6A, an example of an electrode is disclosed in a photographic representation and arranged in its place relative to the bipolar plate 1. In the enlarged view of a square segment, a single feature of the electrode 17 is shown, namely the outline of an orifice in the electrode material. The orifice has an outline shape similar to the sectional shape of a brilliant 22 (diamond cut) with a domed side opposite an angle pointing away from the domed shape. During use, a fluid flow of the electrolyte will be arranged, such that in the space between the bipolar plate 1 and the diaphragm 19, the electrolyte will flow between the spacers from an inlet to an oppositely placed outlet. In certain types of electrodes 17, such as the electrode shown in FIG. 6, it is preferred that this electrolyte flow has a predefined direction relative to a brilliant trace 22 of the orifices. To this end, it is desirous that the electrodes 17 are also oriented in a predefined manner with respect to the bipolar plate 1 prior to the welding process, which fastens the electrode 17 onto the flat top 13 of each spacer 7 at one side of the plate 1. FIG. 6B, in sketch form, shows a line drawing of the photographic representation of FIG. 6A. In the sketch FIG. 6B, the brilliant shape is represented by a simpler geometrical representation, but it will be understood that it should be shaped like a brilliant 22, the standard shape of which (side view) is represented in FIG. 6C.

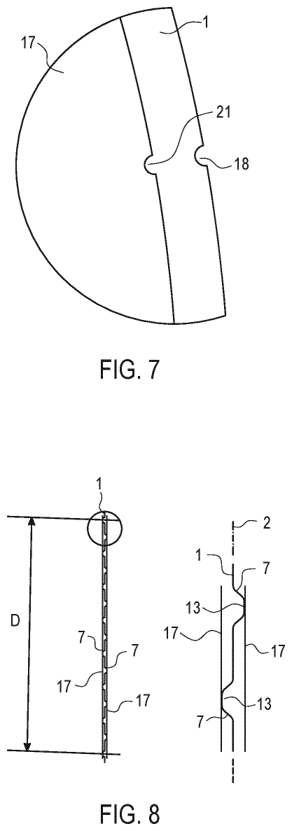

In FIG. 7 and in FIG. 3, it is shown that the bipolar plate 1 has an electrode orientation feature 18, which shall correspond to a similarly shaped orientation marker 21 in the electrode 17. When the electrode orientation feature 18 in the bipolar plate is aligned with the orientation marker 21 in the electrode 17 as seen in FIG. 7, the electrode 17 will be rotated in a predefined manner with respect to the bipolar plate 1, and the two may now be welded to each other in this mutual rotational relationship. Once placed in the cell frame 5 with the orientation tabs 10 placed in the corresponding tab and/or indent 11 at a cell frame 5, it is ensured that in a cell frame, inlets and outlets are automatically arranged to ensure a general flow direction according to the orientation of the brilliant trace 22 of the electrode 17. The inlets and outlets (not shown) at the cell frame and into the electrolytical chambers on each side of the bipolar plate shall thus also be mapped out with respect to the orientation tab and/or indent 11 at the cell frame 5.

In FIG. 8, a schematic representation of a part of the bipolar plate 1 with an electrode 17 welded to each side thereof is disclosed. In the enlarged part to the left in FIG. 8, the flat tops 13 of the spacers 7 are clearly visible.

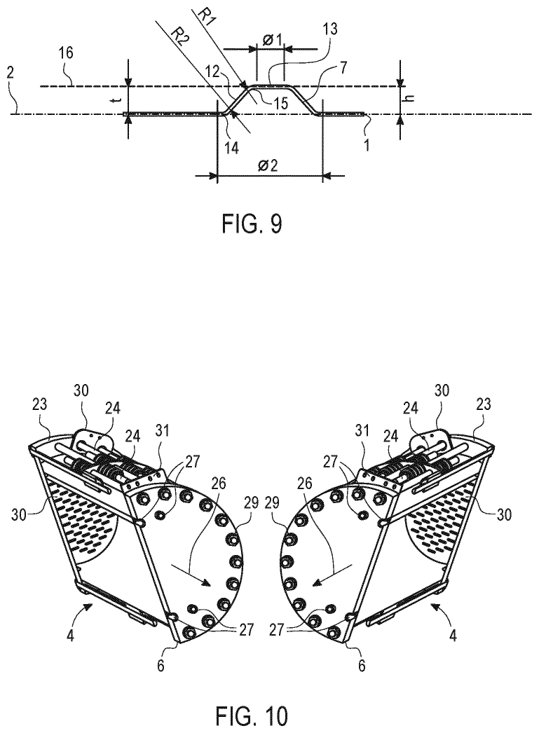

In FIG. 9, a sectional view of one embodiment of a spacer 7 is disclosed. In this embodiment, the spacers 7 are formed as protrusions (or bumps), extending from the plate. In this embodiment, each spacer 7 comprises a circular conical shoulder part 12 rising from the surface 1′, 1″ of the bipolar plate 1, and a flat circular top 13. The shoulder part can also be considered to rise from the midplane 2. A rounded interface 14 is provided between the surface 1′, 1″ of the bipolar plate 1 and the shoulder part 12. Similarly, a rounded interface 15 between the shoulder part 12 and the flat top 13 is provided. Here ∅1 is the diameter of the flat top part 13 of the spacer, R1 and R2 are rounding diameters of the intersection between the midplane 2 and shoulder 14 and the intersection between the shoulder part 12 and the flat top part 13. h is the distance between the virtual plane 16 in which the flat parts 13 reside and the midplane 2. t is the thickness of the bipolar plate 1. ∅2 is the diameter of the spacer 7 from onset of the rounded interface 14 in the midplane 2. If D is the diameter of the outermost circle of spacers 7 when projected onto the midplane 2, it is preferred that the D/h quotient is between 100 and 135, preferably between 115 and 119. In a most preferred embodiment, the D/h quotient is between 116 and 118.

Two cell stacks 4 are shown in FIG. 10 in a sectional view. The inside of the stack 4 which comprises bipolar plates, diaphragms and electrodes are not part of the figure. The stacks are each confined between endplates 6, 23, and sets of pull rods 24 and nuts 29 are provided between the two endplates 6, 23 externally of the cell frames. In this way an internal high pressure may be maintained inside the cell frames 5, as they are urged together between the two endplates 23 by means of the pull rods 24 and corresponding nuts 29. Fluid connection means 27 are provided at one of the endplates, namely the proximal endplate 6 at each cell stack 4. In an embodiment, positive and negative poles of an electric current supply are connected to distal current injection plates 30 provided at the far or distal ends (proximal to distal endplates 23) of the two stacks shown in FIG. 10, whereas proximal current injection plates 31 at the proximal ends of the stacks are short circuited such that electric current shall pass through the one cell stack and into the opposed stack in FIG. 10. At the proximal endplates 6, a zero electrical potential is maintained, possibly also aided by a grounded electrical lead (not shown), and thus it is convenient to provide all of the fluid connection means 27 for the two stacks 4 at the proximal endplates 6. In such an embodiment, all bipolar plates in a first stack shall have their one side, such as the cathode side facing the proximal endplate 6, whereas all bipolar plates in the other stack is to have all bipolar plate cathode sides face the distal end plate 23 of this stack. This arrangement may be provided without further ado by allowing the bipolar plates to be overturned when assembled to the cell frames with say, their cathodes facing either the proximal or the distal endplates throughout the entire stack.

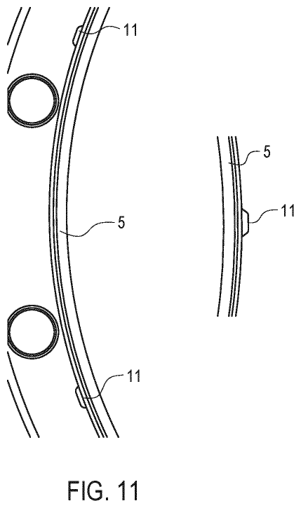

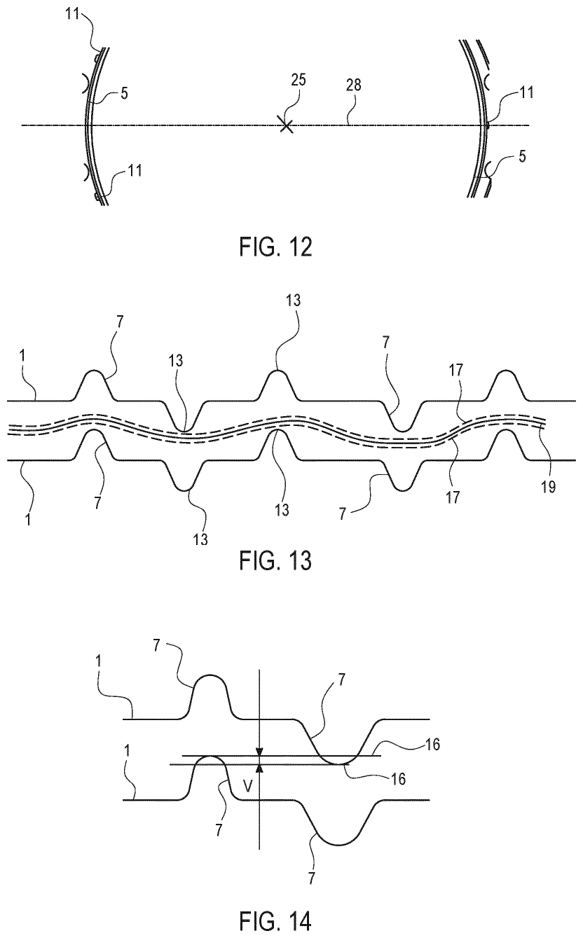

In FIG. 12, part of the same cell frame 5 is shown and on the left-and right-hand sides, the inner rims of the cell frame is shown. On the right-hand side, an orientation indent 11 is shown, along with two similar orientation indents 11 on the left-hand side. As seen in FIG. 12, if a diameter line 28 through the middle of the right-hand side orientation indent 11 is drawn and extended through the centre 25 of the circular structure of the inner rim of the cell frame 5, this diameter line shall be in equal distance from the two left-hand side indents 11. The right-and left-hand side indents are disclosed in FIG. 11 in an enlarged view, as they are barely visible in FIG. 12. When the orientation indents and/or tabs 11, 10 in the cell frame 5 and bipolar plate 1 are symmetrically provided with respect to a diameter 28 line in the plane of the cell frame 5, it allows for the bipolar plate 1 to be flipped or rotated 180 degrees with respect to a cell frame around such a diameter line 28 in the midplane 2 and still fit with tabs/indents at the cell frame 5. As seen in FIG. 3, the bipolar plate 1 has three orientation tabs 10, and thus this plate 1 shall fit a cell frame disclosed in FIG.

11, either as disclosed in FIG. 3 or when overturned around a diameter line 28 extending through the tab 10 shown on the left-hand side in FIG. 3. Overturning around any axis in the midplane of the bipolar plate will do, however, if an axis different from the diameter line 28 is chosen, fitting the cell frame will require further translation and/or rotation of the plate to become aligned with the features in the cell frame after an overturning or flipping action.

It is to be noted that the figures and the above description have shown the example embodiments in a simple and schematic manner. Many of the specific mechanical details have not been shown since the person skilled in the art should be familiar with these details and they would just unnecessarily complicate this description.

### LIST OF PARTS

1 Bipolar plate (plate)
1′ surface of bipolar plate formed on one side of the bipolar plate/first surface of bipolar plate
1″ surface of bipolar plate formed on the other side of the bipolar plate/second surface of bipolar plate
2 Midplane of bipolar plate
3 Electrolyser cell
4 Cell stack
5 Cell frame
6 Proximal endplate
7 Spacer (may be an indention formed in the plate, such that it provides a protrusion extending from a surface/a side of the plate)
8 Concentric circle
9 Centre of concentric circles
10 Orientation tab and/or indent
11 Corresponding tab and/or indent at a cell frame
12 Conical shoulder part
13 Flat circular top
14 Rounded interface between midplane and shoulder part
15 Rounded interface between shoulder part and circular flat top
16 Virtual plane
17 Electrode
18 Electrode orientation feature in bipolar plate
19 Diaphragm
20 EDE or Electrode-diaphragm-electrode sandwich
21 Orientation marker in electrode
22 Brilliant trace (orifice)
23 Distal endplate
24 Pull rods
25 Centre of cell frame inner circular rim
26 Length axis of the stack
27 Fluid connection means
28 Cell frame or bipolar plate diameter line
29 Nuts
30 Distal current injection plates
31 Proximal current injection plates
32 rim of bipolar plate
h height of spacers from midplane to virtual plane
D diameter of outermost ring of spacers on the plate
V distance between adjacent virtual planes in a half-cell
t thickness of EDE sandwich

1. Bipolar plates configured for use in an electrolyser cell stack, wherein each bipolar plate comprises two opposed surfaces and spaced apart spacers extending outwards from a surface of the bipolar plate, characterized in that the spacers are arranged along concentric circles with spacers alternatingly protruding in opposite directions relative to a midplane of the bipolar plate along each concentric circle, and wherein an even number of spacers are provided in each circumferential circle.

2. Bipolar plates according to claim 1, wherein the spacers are formed as protrusions from the bipolar plate.

3. Bipolar plates according to claim 2, wherein the spacers are formed as a essentially semi-spherical protrusions from the bipolar plate.

4. Bipolar plates according to claim 2, wherein the protrusions forming the spacers each comprises a flat top.

5. Bipolar plates according to the claim 1, wherein the nominal thickness of an electrode-diaphragm-electrode (EDE) comprising an electrode, a diaphragm and yet an electrode exceeds the distance between two neighbouring virtual planes with a predetermined measure where the virtual planes inscribe flat tops of protrusions protruding in one direction from the bipolar plate.

6. Bipolar plates according to claims 1, characterized in that at least one orientation tab and/or indent is provided in each bipolar plate (radially external to the outermost circle of spacers whereby the orientation tab and/or indent is located at the same location with respect to the spacers in all plates, such that any spacer is mapped out with respect to at least one tab and/or indent in the same way in all plates.

7. Bipolar plates according to claim 1, wherein each spacer comprises a circular conical shoulder part rising from the surface of the bipolar plate and a flat circular top and rounded interface between the surface of the bipolar plate and shoulder part and similarly rounded interface between the shoulder part and the flat top.

8. Bipolar plates according to claim 7, wherein the flat tops of the spacers protruding from a bipolar plate are inscribed in the virtual plane, and this virtual plane is parallel to the midplane of the plate from which the spacers protrude, and that, if the distance between the virtual plane and the midplane is termed h and the diameter of the outermost of the concentric circles is termed D, then the D/h size relation is no smaller than 100 and no bigger than 135, and preferably is between 115 and 125.

9. Bipolar plates according to claim 1, wherein the number of concentric circles is no less than seven.

10. Bipolar plates according to claim 1, wherein the concentric circles are arranged with equal distances between them, such that in a section through the centre of the concentric circles of spacers, the radial distance from one concentric circle to the next is the same throughout the bipolar plate.

11. Bipolar plates according to claim 1, wherein a single spacer is further provided in the centre of the concentric circles.

12. Use of bipolar plates according to claim 1, characterized in that the bipolar plates during use are arranged in a stack with the EDE sandwich pressurized between spacers of individual bipolar plates, and wherein all bipolar plates have at least one orientation tab/indent aligned with each other in the stack length direction and are further rotated around a cell frame diameter line in the midplane such that all spacers in the plates in a cell stack, which are aligned along a length axis direction of the stack, shall protrude in one predetermined direction only.

13. A method of assembly of a water electrolysis stack holding a range of identical bipolar plates having arrays of identically dispersed spacers 6-extending normally away from opposite surfaces and a midplane of each plate in two opposed directions, characterized in that the bipolar plates throughout the stack are arranged during assembly, such that all spacers in the range of plates are aligned along axes, which are parallel to the length axis of the stack, and wherein all spacers along any one alignment axis protrude in one and the same direction.

14. The method of assembly according to claim 13, wherein during assembly a nominal height measure of the EDE elements of a cell (exceed the distance between the virtual planes comprising the flat tops of spacers in opposed bipolar plates, such that the EDE elements between the spacers will undulate between the two arrays of spacers in the opposed bipolar plates as the stack elements are pressed against each other.

15. The method of assembly according to claim 13, wherein at least one orientation tab and/or indent along an edge part of the otherwise circular bipolar plates is co-aligned with respect to a corresponding tab and/or indent at a cell frame onto which the bipolar plate is mounted.

16. The method of assembly according to claim 13, characterized in that prior to adding a bipolar plate to a cell frame, each spacer protruding from a first side of the bipolar plate is welded to an electrode and that each spacer protruding from a second side of the bipolar plate is welded to a further electrode, whereby the electrodes prior to the welding operation are rotated such that an orientation marker on the electrode is orientated in a predefined manner with respect to an orientation feature in the corresponding bipolar plate.

17. The method of assembly according to claim 13, wherein the bipolar plates are either all rotated to have the cathode electrode face an endplate with inlets and outlets for the electrolysis processes in the stack also named proximal endplate, or the bipolar plates are all rotated to have the cathode electrode face away from the proximal endplate.
